(19) United States
(12) Patent Application Publication
(10) Pub. No.: US 2013/0312698 A1
(43) Pub. Date: Nov. 28, 2013

(54) MS EXTENDED EXPANSION ENGINE

(71) Applicant: Nagesh Siddabasappa Mavinahally, Northridge, CA (US)

(72) Inventor: Nagesh Siddabasappa Mavinahally, Northridge, CA (US)

(21) Appl. No.: 13/676,027

(22) Filed: Nov. 13, 2012

Related U.S. Application Data
(60) Provisional application No. 61/561,922, filed on Nov. 20, 2011.
(60) Provisional application No. 61/567,305, filed on Dec. 6, 2011.
(60) Provisional application No. 61/576,999, filed on Dec. 17, 2011.

(51) Int. Cl. F16C 7/00

(52) U.S. Cl. CPC F16C 7/00
USPC 123/197.4

(57) ABSTRACT

A four-stroke engine incorporating a camshaft-less cam channel assembly configured to operate intake and exhaust valves in an extended expansion engine, wherein the intake stroke is shorter than the expansion stroke controlled cyclically by the control rod through a triplate during the four-cycles of the engine. When the triplate is made of stamped steel plates or stamped steel plates sandwiched together having holes to lighten the weight and connecting rod and control rod are of stamped steel plates. In another embodiment, a twin cylinder extended expansion engine is constructed having many common parts between the two cylinders.

### RELATED APPLICATIONS

The present application claims the benefit of priority of U.S. provisional application No. 61/561,922, filed Nov. 20, 2011 entitled “MONO-SHAFT EXTENDED EXPANSION ENGINE”, U.S. provisional application No. 61/567,305, filed Dec. 6, 2011 entitled “EXTENDED EXPANSION ENGINE”, and U.S. provisional application No. 61/576,999, filed Dec. 17, 2011 entitled “MONO-SHAFT FOUR-STROKE TWIN CYLINDER ENGINE”, filed the entirety of which is incorporated by reference herein for all purposes.

### FIELD OF THE INVENTION

The present invention generally relates to internal combustion engine, particularly to extended expansion four-stroke twin cylinder engine and camshaft-less mono-shaft four-stroke engine.

### PRIOR ARTS

U.S. Pat. No. 7,000,581 issued to Nagesh S. Mavinahally, U.S. Pat. No. 367,496 issued to J. Atkinson, and U.S. Pat. No. 6,814,034 issued to Yoshikazu Yamada et. al. and U.S. Pat. No. 4,517,931 issued to Carl D. Nelson. Technical paper SAE paper number 920452 by Nagesh S. Mavinahally, et. al., 1992. Technical paper SAE number 2010-32-0007 by Shohei Kono, et. al., 2010. U.S. Pat. Nos. 7,185,615, 1,174,801, US Patent publications 20090095261, 20090095262, 20090283073, 20090288641, 20090288642, 20090288643, 20100186721.

### BACKGROUND

A conventional four-stroke engine has a fixed intake and expansion strokes that determine the geometric compression and expansion ratios. SAE paper 920452, authored by Mavinahally, et al. describes the advantages of an extended expansion engine, wherein a longer expansion stroke increases the thermal efficiency of the engine. Also, conventional four-stroke engine has at least one camshaft that runs at half the crankshaft speed. Conventional engines, as we know today are relatively simpler compared to the many prior arts disclosed in U.S. Pat. No. 367,496 issued to J. Atkinson, and U.S. Pat. No. 6,814,034 issued to Yoshikazu Yamada et. al. and U.S. Pat. No. 4,517,931 issued to Carl D. Nelson. Prior arts listed above describe variable displacement four-stroke engines and they have either complex linkages as in Atkinson's patent, requiring a camshaft 53 running at half the crankshaft speed as in U.S. Pat. No. 6,814,034, or an overly off-set control shaft 46 as in U.S. Pat. No. 4,517,931. U.S. Pat. No. 7,000,581 describes a mono-shaft four-stroke engine that has only one shaft and does not require a camshaft to operate valves in a four-stroke engine. The U.S. Pat. No. 6,814,034 describes a camshaft driven by the gears making it expensive and bigger in size. Therefore, there exists a need for a compact and low cost extended expansion engine. Another drawback of prior arts that have complex mechanism to achieve variable displacement/stroke is that they are suitable for single cylinder engines and require multiple linkages to have multiple cylinders. The current embodiment describes an invention that eliminates drawbacks of the prior arts and improves the efficiency of the four-stroke engine by having a longer expansion stroke in relation to the compression. The advantage of the new invention is that the cam lobes can be integral part of the crank web and also the gear on the crankshaft can be integral part of the crank-web, thus reducing the number of moving parts in an engine, and consequently reducing the cost and size of the engine. Secondly, the embodiment discloses a twin cylinder engine, where linkages used for one cylinder are also used for the opposed twin cylinder engine. Thus the new invention reduces the number of parts and eliminates the need for multiple camshafts and linkages to operate a twin opposed cylinder engine.

### SUMMARY OF THE INVENTION

A four-stroke engine that incorporates a mono-shaft multi-valve operating system, the system including the cam follower assembly configured to operate intake and exhaust valves and cam channels, the crankshaft receiving power transmission from the piston through an intermediate triplate and triplate made of light weight stamped or forged steel or aluminum having connecting rod pin at one corner, a control rod pin in another corner, and the crank pin at the third corner, driving the crankshaft. And the piston stroke varies between the intake and the expansion strokes, wherein the expansion stroke is longer than the intake stroke. The piton transmits power through the connecting rod to the tri-plate, which is connected to the conventional crankshaft. The motion of the triplate is also controlled by a control rod which in turn is connected eccentrically to a shaft. The drive between the crankshaft and the shaft is through gears and the ratio between the crankshaft and the gear may range from 1:1 to 1:2 with a variable ratio system (not described here). However, with a fixed ratio, the ratio between the crankshaft and the shaft is about 2:1; in that the crankshaft rotates at about half the shaft speed. The ratio enables the intake stroke to be shorter than the expansion stroke. In another embodiment, the cam channels are integral with the crank web, which can be forged or insert molded or made of powder metal. In a power metal part, cam channel and the counter weight commonly known as crank web can be molded as one piece, which reduces the cost of the part. When the gear and crank web are integral to together, it eliminates the need for a separate part on the crankshaft. In another embodiment, the cam channel and the crank gear can be one piece part. The lubrication system can be similar to any of the convention methods; wet, dry, force lubrication, or mist lubrication type. The crankcase scavenging method can be adopted for improving the charging efficiency of the engine. The triplate is an additional part in comparison to a conventional engine, thus adds cost. However, the triplate can be a simple forged plate or a light weight carbon fiber material or laminated plate or stamped steel plate as used in low cost trimmer engines. Similarly, the control rod can be made of forged plate or laminated plates or stamped steel plate. Yet, in another embodiment, the shaft may be located above the crankshaft, placed closer to the piston and have conventional cam lobes to operate the valves. The fuel used can be gaseous fuel such as LPG, Natural Gas, or even liquid fuels. In another embodiment a twin cylinder arrangement using the common gears and particularly the triplate (now called quadplate) is used to lower the cost and improve the efficiency of packaging and fuel consumption. Yet, in another embodiment the mono-shaft engine having equal expansion and compression ratios can also be designed to be a twin-cylinder engine to minimize the number of parts by having a common cam channel while the cylinders are either opposed or opposed and offset. In another embodiment a mono-shaft four-stroke engine described in U.S. Pat. No. 7,000,581 issued to Nagesh S. Mavinahally is improved to have a twin-cylinder arrangement so as to reduce the number parts compared to conventional twin-cylinder engine.

### BRIEF DESCRIPTION OF THE DRAWINGS

Many aspects of the inventions can be better understood with reference to the following drawings. The components in the drawings are not necessarily drawn to scale, emphasis instead being placed upon clearly illustrating the principles of the present invention.

FIG. 1 is a Sectional side view of the embodiment of an extended expansion engine incorporating a mono-shaft engine valve operating system and having cylindrical fuel tank attached to the engine.

FIG. 2 is side sectional view of engine of FIG. 1

FIG. 3 is side sectional view of alternative embodiment of engine of FIG. 1 having crank gear and cam channel on the crank webs and inside the crankcase chamber.

FIG. 4 is side sectional view of alternative embodiment of engine of FIG. 1 having crank gear inside the crankcase chamber.

FIG. 5 is a side sectional view of half crank extended expansion engine incorporating mono-shaft valve operating system.

FIG. 5 is view of the triplate made of stamped steel plates laminated together.

FIG. 6 is a view of the triplate made of at least two stamped plates joined together and having formed ribs to strengthen the plate.

FIG. 7 is a view of the triplate made of at stamped plates sandwiched together and having holes to lighten the weight.

FIG. 8 is a sectional side view of another embodiment of extended expansion engine having common parts.

FIG. 9 is a perspective view of a opposed twin cylinder engine 3100 incorporating a mono-shaft engine valve operating system.

FIG. 10 is an elevational view of the opposed twin cylinder mono-shaft engine 3100, shown in FIG. 9 having center axis of cylinders in one line, when viewed from the intake valve side, with twin cam followers assembly disposed in a cam rail of a cam follower rail assembly shared by the two valve train assembly.

FIG. 11 is an elevational view of the opposed twin cylinder mono-shaft engine 4100 having center axis of cylinders off-set, when viewed from the intake valve side, with twin cam followers assembly disposed in a cam rail of a cam follower rail assembly shared by the two valve train assembly.

FIG. 12 is a cross sectional view of the cam follower.

### DETAILED DESCRIPTION OF THE PREFERRED EMBODIMENTS

While the description below refers to certain exemplary embodiments, it is to be understood that invention is not limited to these particular embodiments. On the contrary the intent is to cover all alternatives, modifications and equivalents included within the spirit and scope of the invention as defined by the appended claims. Also, terminology used herein is for the purpose of description and not limitations.

Four-stroke engine 100 generally comprises a cylinder block 10 that includes a cylinder bore 12. A piston 140 reciprocates within the bore 12 and is connected by means of a connecting rod 150 to a crank pin 155 associated with triplate 902. The reciprocating motion of the piston 140 is translated into rotary motion of crankshaft 160 through the triplate 902 associated with the crank web 32 through a crank pin 936. The trip plate 902 is also associated with shaft 24 through a control rod 224 associated through control rod pin 236. The shaft 224 is connected to the control rod 224 through the eccentric 24b on the shaft 24. The shaft and crankshaft are interconnected through shaft gear 950 and the crankshaft gear 948 at about 2:1 ratio. That is; the diameter of the crankshaft gear 948 is half the diameter of the shaft gear 950. The eccentricity also determines the difference in stroke length of intake and expansion strokes. Typically the ration of expansion ratio to compression ratio is about 1. That is; if the compression ratio is 10:1, the expansion ratio is 15:1. Thus the thermodynamic efficiency of the engine is significantly better than a conventional engine where the compression ratio is same as expansion ratio. The crankshaft 160 is journaled for rotation within a crankcase chamber 161 of a crankcase 165 that is affixed to the lower end of cylinder block 10. The cylinder block may also be of mono-block type where the upper cylinder block 10 and the crankcase 165 as an integral cast block. Alternately the upper half of the crankcase may be integral with the cylinder block, while lower crankcase is a separate piece. The crankshaft 160 can be a half crank as in a low cost half crank trimmer engine, where the crankshaft is journaled on one side only.

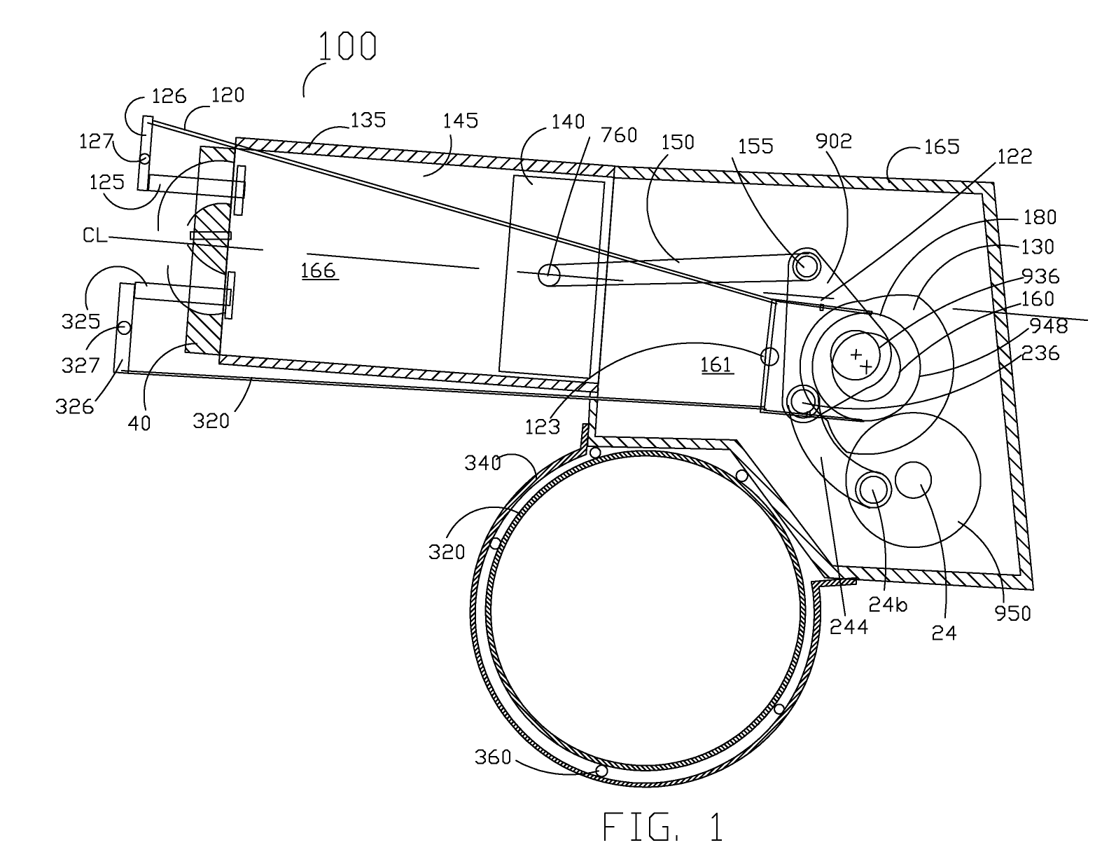

Referring to FIG. 1, piston 140, crankshaft 160, and shaft 24 carried in crankcase 165 of the engine 100 are in a plane passing through axis of the cylinder bore 145 and perpendicular to the axis of the crankshaft 160, are connected to one another through the triplate link mechanism 904.

The link mechanism 904 includes a connecting rod 150 having a piston pin 760 for piston 140 at one end; a triplate 902 connected to the crankshaft 160 through a crank pin 936 and rotatably connected to the other end of the connecting rod 150 through a connecting rod pin 155; and a control rod 224, which is rotatably connected at one end to the triplate 902 at a position displaced from a connection position of the connecting rod 150. The control rod 224 is rotatably supported at other end on the eccentric 224 on the shaft 24 so that the support position can be displaced in a plane perpendicular to the axis of the crankshaft 160.

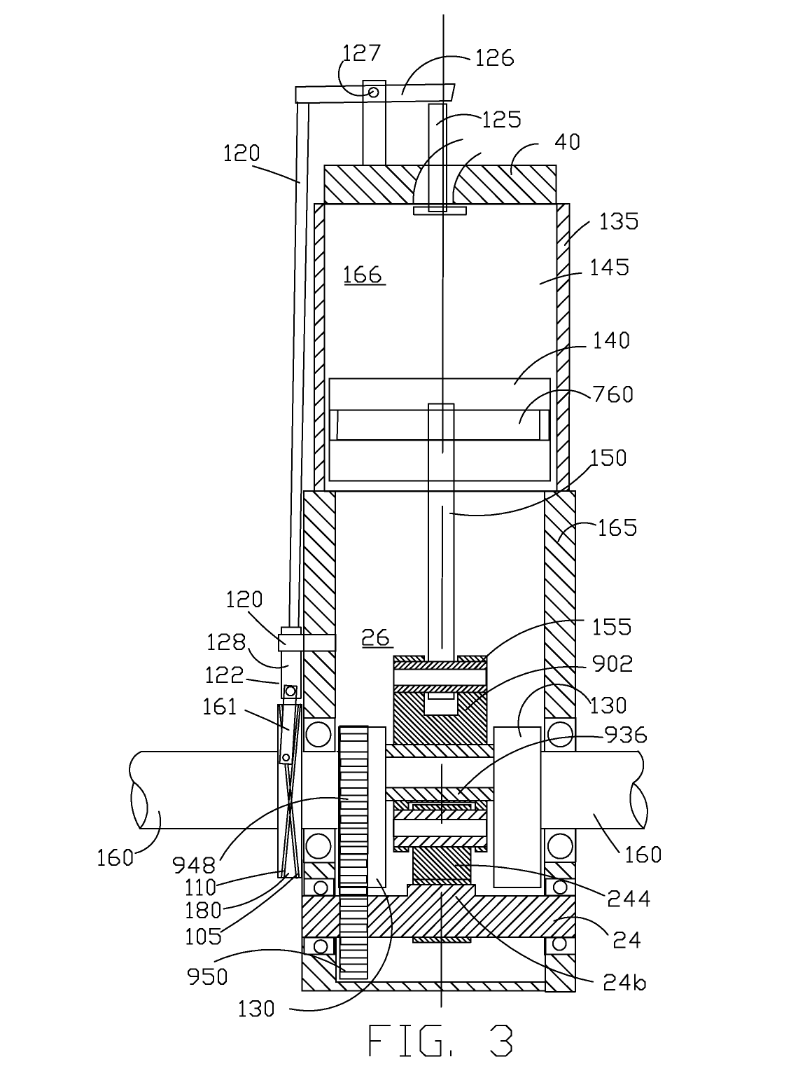

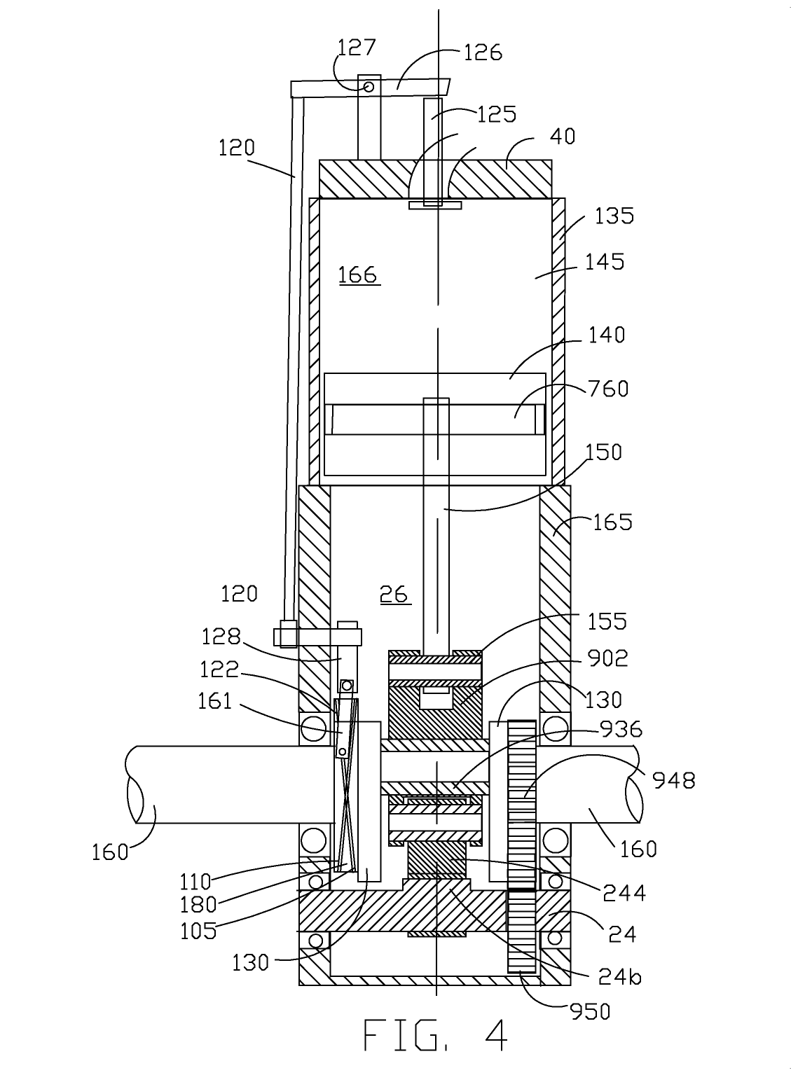

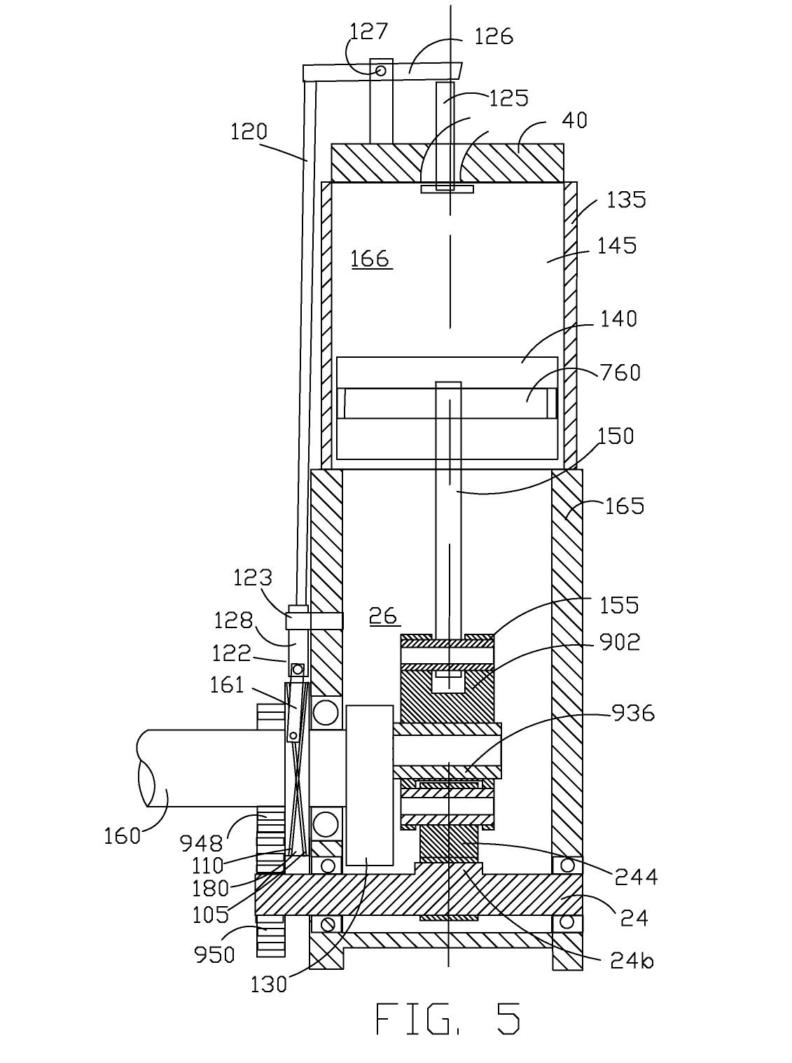

The shaft 24 rotatably carried in the crankcase 165 is parallel to the crankshaft 160. The shaft 24 has an eccentric section 224 to displace the control rod 224 in a cyclic manner, which in turn affects the position of the triplate accordingly and affects the stroke of the piston cyclically. The shaft 24 has a shaft gear 950 rigidly attached to the shaft 24 at one end outside the crankcase chamber 161. However, in another embodiment the shaft gear is inside the crank chamber 161, as shown in FIG. 3 and FIG. 4.

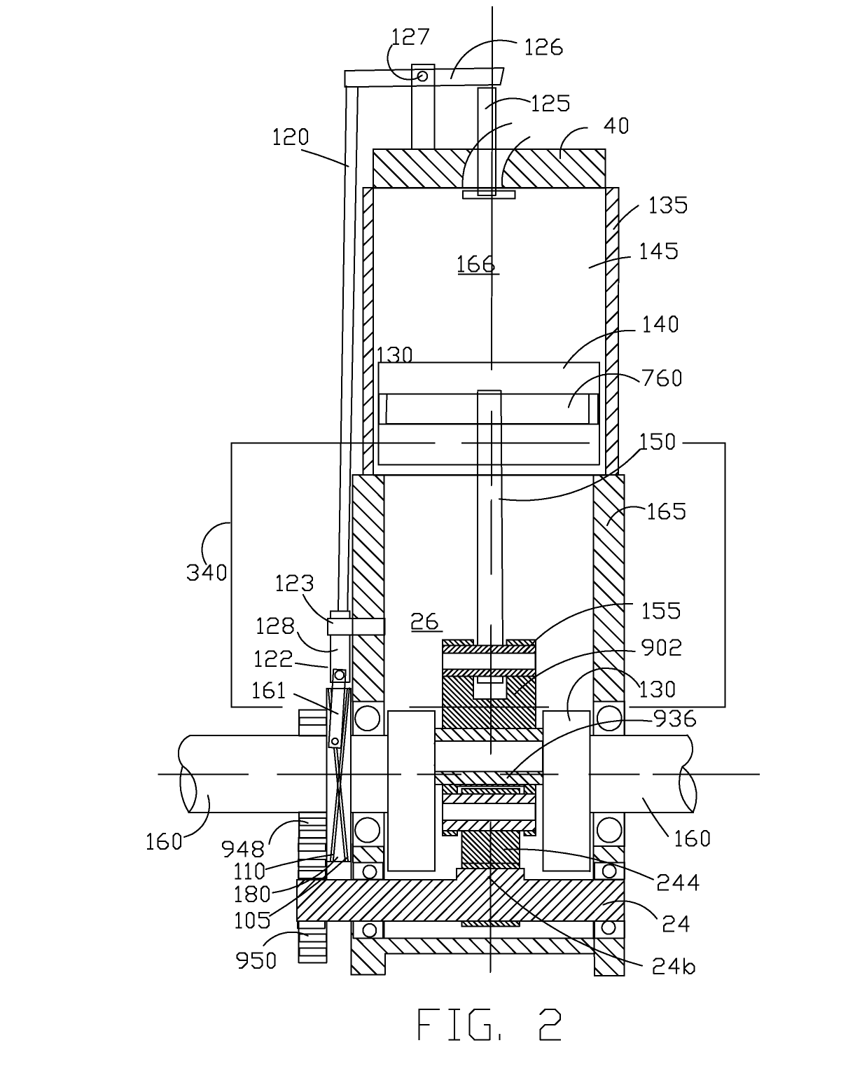

FIG. 2 Shows the side sectional view of the engine 100 showing cam channel assembly 122 and the crankshaft gear 948 on the crankshaft 160 located outside the crankcase chamber 161.

FIG. 3 shows cam channel assembly 122 outside the crankcase chamber 161, where as the crankshaft gear 948 and shaft gear 950 are located inside the crankcase chamber 161. The crankshaft gear may be an integral part of the crank web 130 or the gear may be attached to the web. The shaft gear 950 is also inside the crankcase chamber 161. This arrangement is compact in size and also the gears are always in the lubricating oil within the crankcase chamber.

FIG. 4 shows the cam channel assembly 122 and the pair of gears 948 and 950 are inside the crank case chamber 161. The cam channels are integrated into crank web 130. However, the push tubes 120 and 320 are outside the crankcase chamber and having the pin 123 protrude through the crankcase 165, requiring additional arm to activate the push tubes.

FIG. 5 shows a half crank engine 110 having the crankshaft 160 on inboard side of the engine, while the shaft 24 is either supported on both ends of the shaft of cantilevered through at least two bearings to increase the robustness. The advantage with the half crank shaft engine is that the assembly of the triplate is easier as there is no need for crank cap (numeral 73) as described in prior art U.S. Pat. No. 6,814,034.

A combustion chamber 166 is defined by a region within the cylinder block 10 above the piston 140. Intake valve 125 is an engine valve that operates to allow a fuel-air mixture into the combustion chamber 166 at suitable interval of the four-stroke cycle. Exhaust valve 325, a second engine valve of engine 100, operates to allow exhaust gases to exit combustion chamber 166 at suitable interval of the four-cycle.

In this exemplary embodiment, the engine valve operating system can be defined as a channel assembly operating multiple valves. The multi-valve operating system incorporates a first cam follower assembly 122 that is associated with intake valve 125, a second cam follower assembly 322 that is associated with exhaust valve 325, and a cam follower channel assembly 180 that is integrated into crank web 130a of engine 100, the cam follower channel assembly 180 including a base circle channel 105, a cam channel 110, and a cross-over channel 111. The channel assembly 180 may be non-integral as shown in FIG. 2. Or integral into crank web 130a as shown in FIG. 4.

Cam follower assembly 122 that is associated with intake valve 125, will now be described in further detail. Intake valve 125 is connected to one end of a pivoting linkage arm 126 that pivots on pivot pin 127 that is mounted on the top surface of engine block 135. The other end of pivoting linkage arm 126 is attached to a top end of push tube 120. This configuration permits a vertical downward-upward movement of push tube 120, which occurs during a 4-stroke engine cycle, to operate intake valve 125 in a correspondingly upward-downward vertical movement.

Cam follower assembly 122 may be generally defined as comprising an L-shaped follower arm 161 that is secured at one end of the L-shape to a free-standing pivot pin 123, and wherein the other end of the L-shape of follower arm 161 is attached to a transverse follower arm 128 that is in slideable contact with crankweb 130. The slideable contact of transverse follower arm 128, which provides the pivoting action for L-shaped follower arm 161, will be explained in further detail later. The bottom end of push tube 120 is connected to the vertex of the L-shaped follower arm 161. With this configuration, push tube 120 is urged to reciprocate up and down whenever follower arm 161 pivots on pivot pin 123. The pivoting action of follower arm 161 is in correspondence to a rotation of the cam follower channel assembly 180 that provides a camming function. This camming function will be described later. The cam follower assembly for the exhaust valve 325 is similar to the operation of the intake valve 125, but occurs at a different stroke of the four-cycle as in a conventional four-stroke engine.

The slideable contact of transverse follower arm 128 of cam follower assembly 122, with crankweb 130 will now be explained. It will be understood that the configuration and description of operation of cam follower assembly 122 that is associated with intake valve 125, is correspondingly applicable to the configuration and description of operation of cam follower assembly 322 that is associated with exhaust valve 325.

In this exemplary embodiment, transverse follower arms 128 and 328 are in slideable contact with a single, commonly-shared cam follower channel assembly 180 that is incorporated into crankweb 130. In other embodiments, a multiplicity of cam follower channel assemblies may be incorporated directly on a single, commonly-shared crankweb, or, alternatively, one or more channel assemblies that are incorporated into one or more disks that are rotatably attached to a common crankshaft, may also be used.

Cam follower assembly 122 comprises L-shaped follower arm 161, transverse follower arm 128, pivot pin 124, and follower 121. Transverse follower arm 128 is pivotably attached to follower arm 161 through pivot pin 124, and is configured to describe a transverse movement. Follower 121 is mounted on transverse follower arm 128 at a distal end away from the end of transverse follower arm 128 that is connected to pivot pin 124.

Follower 121 may comprise a cylinder element, an oval-shaped sliding element, a roller element, a ball element, a spring element, or any other element that provides slideable or rollable contact with channels 105 or 110 of cam follower channel assembly 180, such contact being provided at one or more points such as the sidewalls or bottom surface of either channel.

Follower 121 is slideably housed inside one of channels 105 or 110 of cam follower channel assembly 180 that is cut in crankweb 130. This configuration permits follower 121 to slidingly track either channel thereby urging transverse follower arm 128 to pivot transversally when crankweb 130 rotates during a 4-stroke cycle.

Follower 121 alternately slides in channels 105 and 110, and operates intake valve 125 once in every two rotations of crankweb 130. This will be explained in greater detail later. The 2-cycle rotation of crankweb 130 and corresponding one-time valve operation conforms to conventional 4-cycle engine operating conditions wherein a conventional camshaft operates at half the engine rotational rate.

The cam follower channel assembly 180 that is circumferentially cut into crankweb 180, and includes a base circle channel 105, a cam channel 110, and a cross-over channel 111. FIG. 4a illustrates a profile view of crankweb 130 as viewed in the direction of arrow 401. Base circle channel 105 is a circular tracking guide mechanism that provides circumferential contact to follower 121 and maintains follower 121 in a constant circular radial distance with reference to cranksahft 160 during one rotation of crankshaft 160. During this rotation of crankshaft 160, L-shaped follower arm 161 maintains resilient inward pressure upon transverse follower arm 128 to place arm 128 in slideable contact with base circle channel 105. Push rod 120 that is connected to cam follower assembly 122 retains a downward elevational position thereby causing intake valve 125 to remain closed. At the end of this rotation, follower 121 is urged by cross-over channel 111 into the cam channel 110.

During a second rotation, cam channel 110 provides a camming action by applying radially outwards-extending pressure upon follower 121, and urging cam follower assembly 122 in the direction of arrow 101 shown in FIG. 4a. When cam follower assembly 122 is urged by this camming action, pushrod 120 is urged upwards and associated intake valve 125 is fully opened once when the follower 121 is located at the general apex of the cam.

Therefore, two rotations of the crankshaft 160 corresponds to an opening of the intake valve once. Intake valve 125 remains closed when follower 121 is positioned on base circle channel 105 at circumferential location 103, and intake valve 125 is open when follower 121 is positioned on cam channel 110 at circumferential location 102.

While cam follower assembly 122 is engaged by cam follower channel assembly 180 to provide intake valve operation, cam follower channel assembly 180 also provides simultaneous exhaust valve operation by simultaneously engaging with cam follower assembly 322. Operation of the exhaust valve 325 is similar to that of the intake valve, and opening of the exhaust valve 325 also occurs once every two rotations of the crankshaft 160. While any two consecutive rotations of crankshaft 160 is accompanied by one opening of intake valve 125 and one opening of exhaust valve 325, the openings are non-concurrent and are configured to occur at optimal moments of the 4-stroke engine cycle.

When crankshaft 160 rotates, the apex of cam channel 110 urges cam follower assembly 122 radially outwards at a first instance, the apex of cam channel 110 then urges cam follower assembly 322 radially outwards at a second instance. The difference in time between the first and second instances is attributable to the rotational speed of the apex of cam circle 110 and the positioning of the two cam follower assemblies along the circumference of crankweb 130. The relative distance along the circumference may be set such that the two assemblies are located diagonally opposing each other, in a 180 degrees relationship. Alternatively, they may be set at angles greater than or less than 180 degrees, such angles being shown by arrows 445 and 446. These angles can be used to advance or delay the opening of exhaust valve 325 with reference to the opening of intake valve 125. Such advancing or delaying is used to modify the expansion to compression ratio of engine 100.

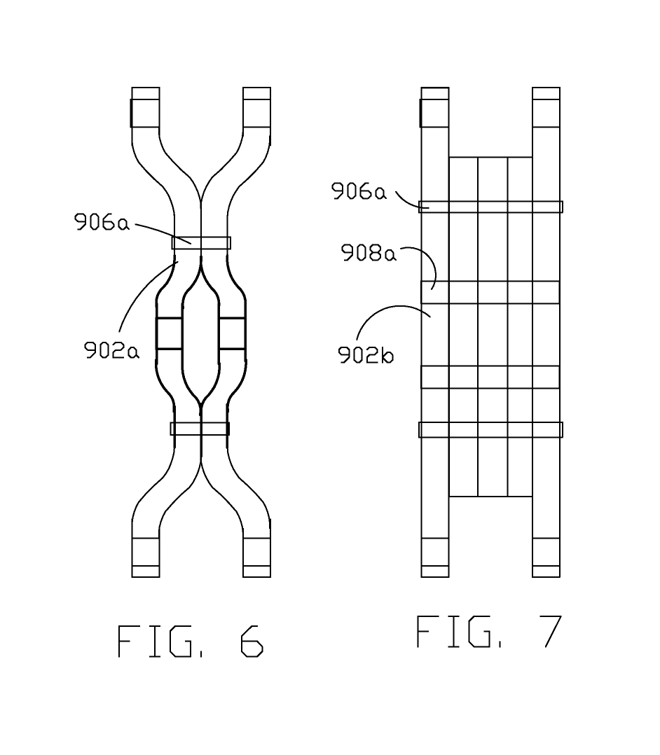

FIG. 6 illustrates a special triplate assembly 1904 made out of stamped steel plates 1906 and 1908 having a bore 2155 for the connecting rod 150, and the bore 2236 for the control rod 224. The assembly may be made simple by simply press fitting the respective pins into the bores to assemble the connecting rod 150 and the control rod 224. However, it may be necessary to have the crank pin cap if the crankshaft is a forged one piece crankshaft or pre-assemble the triplate 902 into the crankshaft assembly if the crankshaft is a three piece assembly (crank pin 936 and the two separate crank webs). The advantage with two stamped triplate is that they are easy to make and cost less.

FIG. 7 illustrates a another embodiment of the triplate where multiple stamped plates are sandwiched together to form the triplate. Again the advantage is low cost and robust design. The plates may be riveted together by the rivet 906a and the sandwiched plates may also have holes 908a to lighten the weight. Similarly the connecting rod and control rod may be made of stamped steel plates, with or without bearing cages pressed into the bearing bores at each end of the rods.

FIG. 1 illustrates location of the cylindrical metal fuel tank 3020 containing LPG fuel or Butane fuel or any gaseous fuel. The fuel tank is attached to the crank case 165 by means any clamping device, preferably having a separate frame for the fuel tank. The fuel tank may be simply slid down into the tank frame 3040 and the frame may have rubber blocks 3060 to dampen the vibration of the tank. The center of the axis of the cylindrical fuel tank is substantially parallel and is above the center line of the crankshaft.

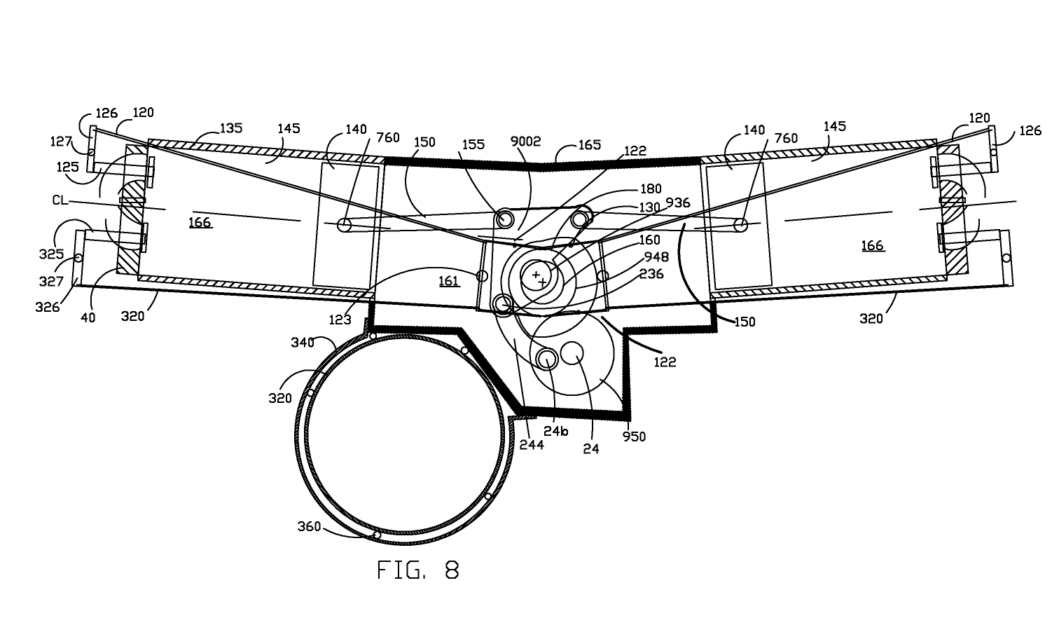

FIG. 8 illustrates an engine similar to the embodiment shown in FIG. 1, but has a twin cylinder arrangement having common linkage through the triplate 9002, also now called a quadplate. The advantages are significant in terms of reducing the number of elements needed to build a twin cylinder engine in comparison to a conventional engine or as described in U.S. Pat. No. 6,814,034 issued to Yoshikazu Yamada et. al. and U.S. Pat. No. 4,517,931 issued to Carl D. Nelson.

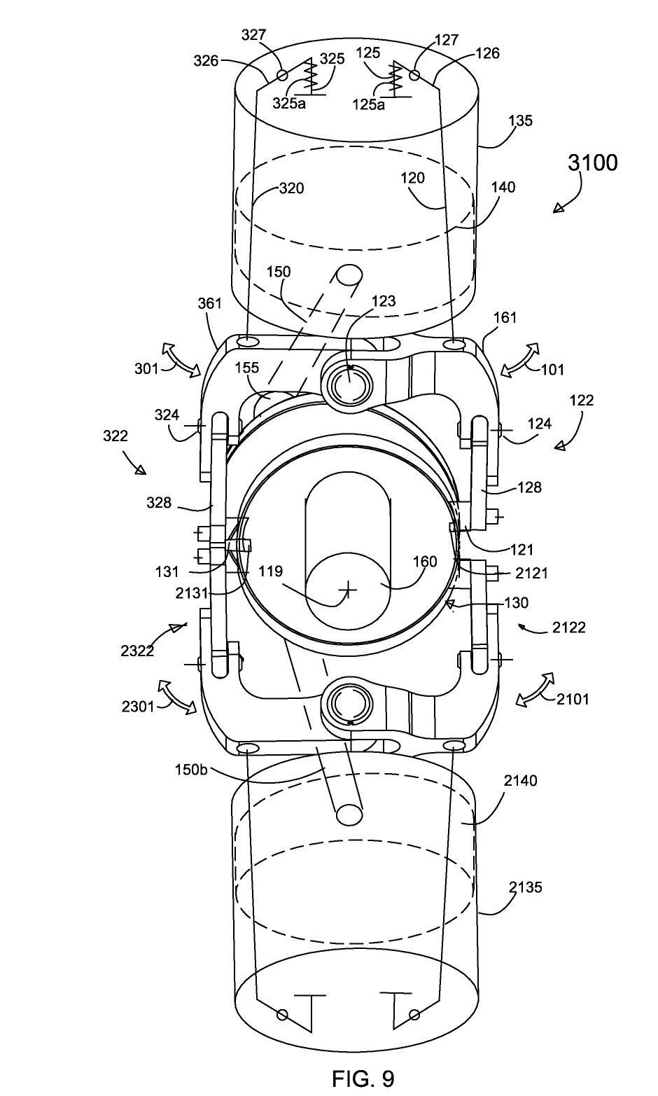

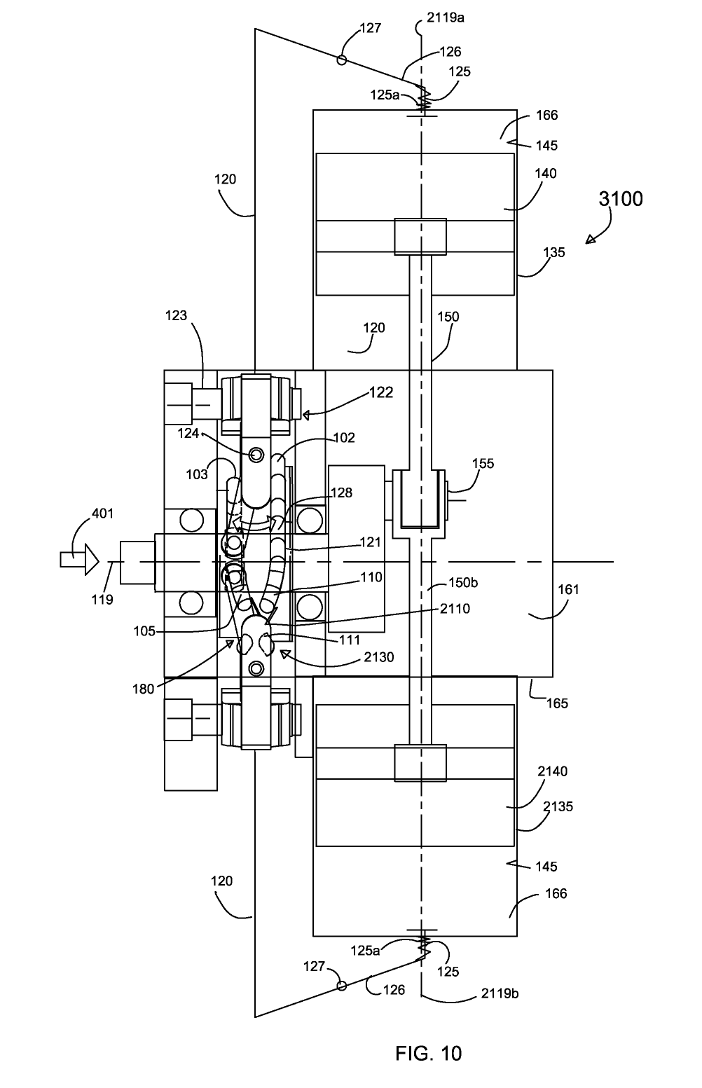

FIGS. 9 and 10 show arrangement of an opposed twin cylinder mono-shaft engine 3100. The construction of the engine is similar to engine 100 shown in FIG. 1 and FIG. 2 and described in the U.S. Pat. No. 7,000,581 issued to Nagesh S. Mavinahally. However, it must be noted that there is a second cylinder whose parts are very similar to engine in FIG. 1, but the cylinder 2135 and piston 2140 are arranged substantially apart at about 180 degrees to the cylinder 135. It must also be noted that engine 100 and 31 00 share a common crankshaft 160 and the cam rail assembly, but have separate cam follower assemblies 2122 for intake valve and 2301 for exhaust valve. The advantage of such a multiple cylinder assembly is that cam rail assembly can be shared between cylinders, thus reducing the number of parts compared to conventional four-stroke engines. The cam rails described in the embodiments may be made of stamped sheet metals plates of significant thickness, such that one such sheet plate can form a rail for cam and another for base circle. Alternately, multiple sheet metal plates to form the required thickness may be riveted or pressed together. When, multiple sheets are riveted to form a rail for intake and exhaust cams, plates of smaller diameter can form cross over. It must be noted that cross over is not necessary if the followers 121 and 131 are of suitable lengths such that when the follower has to switch over from one rail to the other, it automatically crosses over without repeating the path on the same rail. Extension tab 2121 and 2131 on the followers 121 and 131 as shown in FIG. 12 may guide each of the followers during switchover to follow the respective rails. The top surface of the rail can be square in section or rounded with a suitable radius at the corners. The contact surface between the followers and the rail may be of special materials than the base rail to improve the wear and lubrication. The rail may also be made of plastic material and insert molded on to the crankshaft 160 or the crank web 130 or the disk 2130. The flowers 121 and 131 may have rollers shaped like rail wheels to guide the wheels on the cam rails.

In another embodiment, the commonly known decompression mechanism may be incorporated on the disk to help start the engine.

FIG. 10 shows an opposed cylinder twin engine 3100, where the connecting rod 150 of one cylinder may be attached to the same crankpin 155 as the connecting rod 150b of the other engine. The angle between the two cylinders may vary. FIG. 10 shows where the angle between the two opposed cylinders is substantially at 180 degrees and the axis of two cylinders are in the same plane long the axis of the cylinders and is perpendicular to the axis 119 of the crankshaft 160.

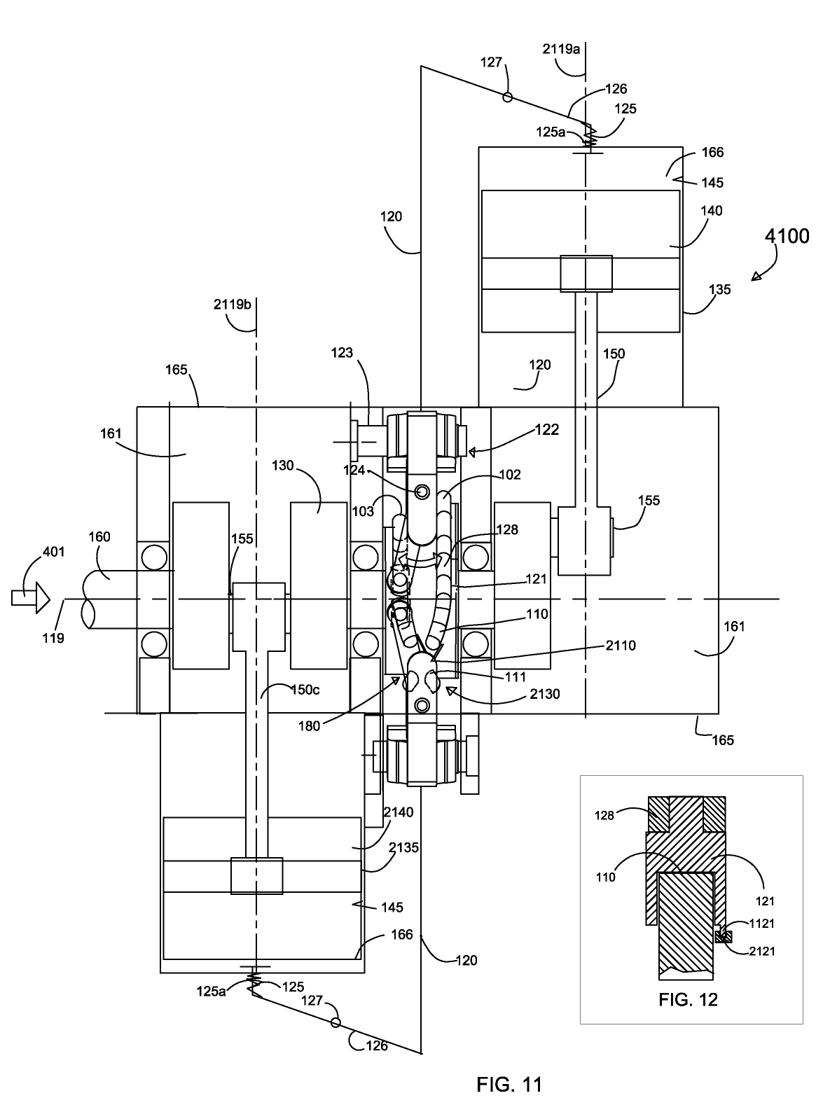

FIG. 11 shows an opposed cylinder twin engine 4100, where the connecting rod 150 of one cylinder may be attached to the same crankshaft 160, but the two cylinders are spread apart with the cam assembly disk 2130 between the two cylinders. The angle between the two cylinders may vary. FIG. 11 shows where the angle between the two opposed cylinders in substantially at 180 degrees and the axis of two cylinders are in two different planes spread apart but parallel to each other and are perpendicular to the axis 119 of the crankshaft 160. Both the engines shown in FIGS. 10 and 11 share a common cam assembly disk 2130.

It is also possible to have a twin cylinder arrangement having a single crankshaft belt pulley to operate two overhead camshafts, one on each cylinder of the opposed twin-cylinder engine.

I claim:

1. A four-stroke engine comprising:
a cam channel assembly with the followers configured to operate the intake and exhaust valves without a separate camshaft,
a piston connected to crankshaft through a connecting rod and a triplate, and
a control rod connected to the triplate to cyclically alter the stroke lengths of the piston during four-cycles of the engine.

2. A four-stroke engine comprising:
a cam channel assembly with the followers configured to operate the intake and exhaust valves without a separate camshaft,
a piston connected to crankshaft through a connecting rod and a triplate,
a control rod connected to the triplate to cyclically alter the stroke lengths of the piston during four-cycles of the engine,
two cylinders arranged opposite to one another;
two pistons one in each opposed cylinders connected to a common triplate through the respective connecting rods; and
each of the connecting rod connected to a common crankshaft through a common.

2. A four-stroke internal combustion engine (3100) that incorporates a mono-shaft multi-valve operating system, the system comprising:
a first cam follower assembly configured to operate an intake valve of the engine;
a second cam follower assembly configured to operate an exhaust valve of the engine;
a cam follower rail assembly comprising a base circle rail circumferentially cut in a crank web of the engine, a cam rail circumferentially cut substantially parallel to the base circle rail, a crossover cut to provide rail interconnectivity between the base circle rail and the cam rail, wherein when the first cam follower assembly is slideably engaged to the cam rail the exhaust valve is operated during a first-half rotation of the crank web, and wherein when the second cam follower assembly is slideably engaged to the cam rail the intake valve is operated during a second-half rotation of the crank web;
two cylinders arranged opposite to one another;
two pistons one in each opposed cylinder connected to a common crankshaft through respective connecting rods; and
each of the connecting rod having a common crankpin attached to at least one crank web on a common crankshaft.
